(19) United States
(12) Patent Application Publication
(10) Pub. No.: US 2026/0112198 A1
(43) Pub. Date: Apr. 23, 2026

(54) Generating Certifications For Facial Images

(71) Applicant: Oracle International Corporation, Redwood Shores, CA (US)

(72) Inventors: Doug Chivers, Hereford (GB); Jakub Wojciak, North Vancouver (CA); Manoj Kumar Gaddam, Gurgaon (IN)

(73) Assignee: Oracle International Corporation, Redwood Shores, CA (US)

(21) Appl. No.: 18/919,254

(22) Filed: Oct. 17, 2024

(51) Int. Cl. G06V 40/16; G06F 21/32; G06V 10/74; H04L 9/32

(52) U.S. Cl. CPC G06V 40/172; G06F 21/32; G06V 10/761; G06V 40/166; H04L 9/3247

(57) ABSTRACT

A system captures a facial image of a human face, and at approximately a same time as capturing the facial image of the human face, the system captures a three-dimensional spatial representation of the human face. The system determines that the facial image corresponds to the three-dimensional spatial representation, and responsive to determining that the facial image corresponds to the three-dimensional spatial representation, the system generates a certification corresponding to the facial image. The system stores and/or transmits the certification for use in a process for authenticating the facial image.

### TECHNICAL FIELD

The present disclosure relates to generating facial images that represent a human face that are utilized, for example, for identification, analysis, or recognition purposes. More particularly, the present disclosure relates to generating certifications for facial images to demonstrate that the facial images are authentic as well as authenticating facial images based the on the certifications.

### BACKGROUND

Facial images are utilized in verification systems by comparing the visual characteristics of a person's face with a stored facial image. When a person presents themselves for verification, their live image is captured using a camera, and facial recognition software analyzes facial features, such as the distance between the eyes, the shape of the nose, and the contours of the jaw. The facial features that are analyzed are referred to as facial landmarks. The facial features, or facial landmarks, are extracted and compared to the facial image to determine if there is a match.

Facial images are utilized in biometric verification systems that verify a person's face against a facial image. The biometric verification process involves creating a digital representation, or facial template, from a live image of the person's face and comparing the facial template to a stored facial image using algorithms that measure similarity. If the comparison of the facial template to the facial image yields a high enough degree of similarity, the system confirms the person's identity. Biometric verification is utilized in various security applications, such as unlocking smartphones, accessing computing systems, accessing secure facilities, and verifying identities at border checkpoints.

In addition to biometric verification systems, facial images are utilized on physical and/or digital identification documents, such as identification cards, access credentials, passports, and driver's licenses. These physical identification documents include a printed facial image that allows a human, such as a security officer or a clerk, to perform a visual verification that the person presenting the physical identification document is the person depicted in the facial image. Visual verification provides a straightforward way of verifying identity. Visual verification may be performed in conjunction with biometric verification performed by a biometric verification system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram that depicts an example computing architecture for generating and authenticating certifications for facial images in accordance with one or more embodiments;

FIG. 2A illustrates example operations associated with generating a certified facial image in accordance with one or more embodiments;

FIG. 2B illustrates example operations associated with authenticating a facial image based on a certification for the facial image in accordance with one or more embodiments; and

FIG. 3 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE SYSTEM ARCHITECTURE FOR GENERATING AND AUTHENTICATING FACIAL IMAGES
3. EXAMPLE OPERATIONS FOR GENERATING AND AUTHENTICATING FACIAL IMAGES
4. COMPUTER NETWORKS AND CLOUD NETWORKS
5. MICROSERVICE APPLICATIONS
6. HARDWARE OVERVIEW
7. MISCELLANEOUS; EXTENSIONS

### 1. General Overview

One or more embodiments generate a certification for authenticating a facial image of a human face in response to determining that the facial image matches a three-dimensional spatial representation of the human face that was captured at approximately a same time as the facial image. The certification provides assurance that the facial image depicts the human face of a person that is intended to be represented by the facial image. The certification may be utilized to inhibit attempts to generate false facial images, such as images that are generated by artificial intelligence, facial images that are modified to change an appearance of the person depicted in the facial image, and/or facial images that depict a different person.

In one example, a system captures a facial image of a human face, and at approximately a same time as capturing the facial image of the human face, the system captures a three-dimensional spatial representation of the human face. The system determines that the facial image corresponds to the three-dimensional spatial representation. In response to determining that the facial image corresponds to the three-dimensional spatial representation, the system generates a certification corresponding to the facial image. The system stores and/or transmits the certification for authenticating the facial image.

Additionally, or alternatively, the system receives and/or accesses a facial image of a human face and a certification for the facial image of the human face. The system executes a process for validating the certification for the facial image. In response to successfully authenticating the certification for the facial image, the system determines, based on the certification having been validated, that the facial image is authentic. Upon determining that the facial image is authentic based on the certification, the system stores and/or transmits an indication that the facial image is determined authentic. In one example, upon determining that the facial image is authentic based on the certification having been validated, the facial image may be provided for use in one or more biometric verification systems. Additionally, or alternatively, the facial image may be provided for use in one or more physical identification documents upon determining that the facial image is authentic based on the certification.

One or more embodiments described in this Specification and/or recited in the claims may not be included in this General Overview section.

### 2. Example System Architecture for Generating and Authenticating Facial Images

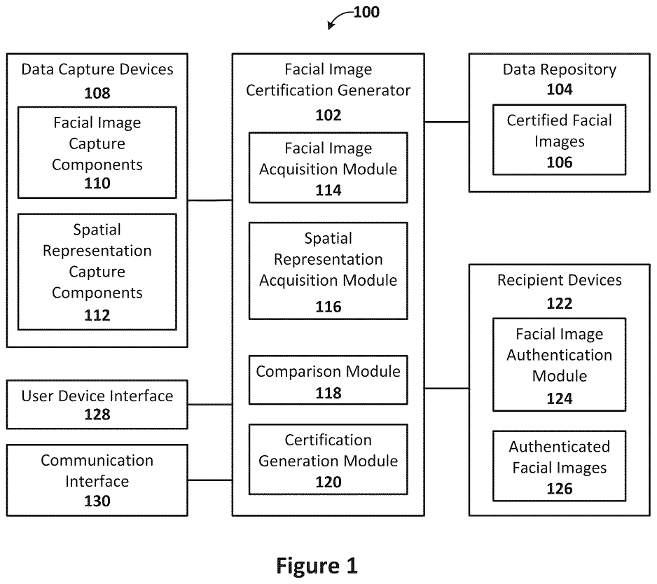

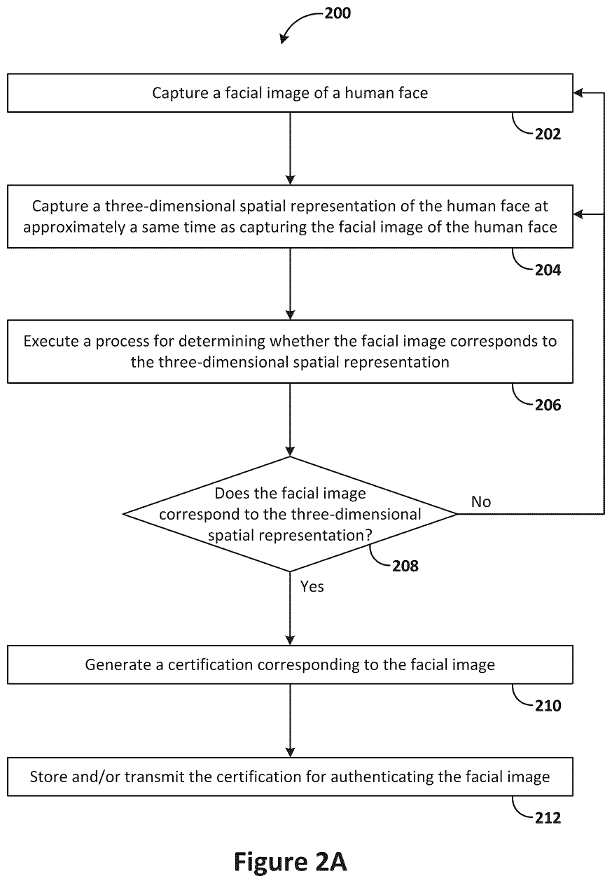

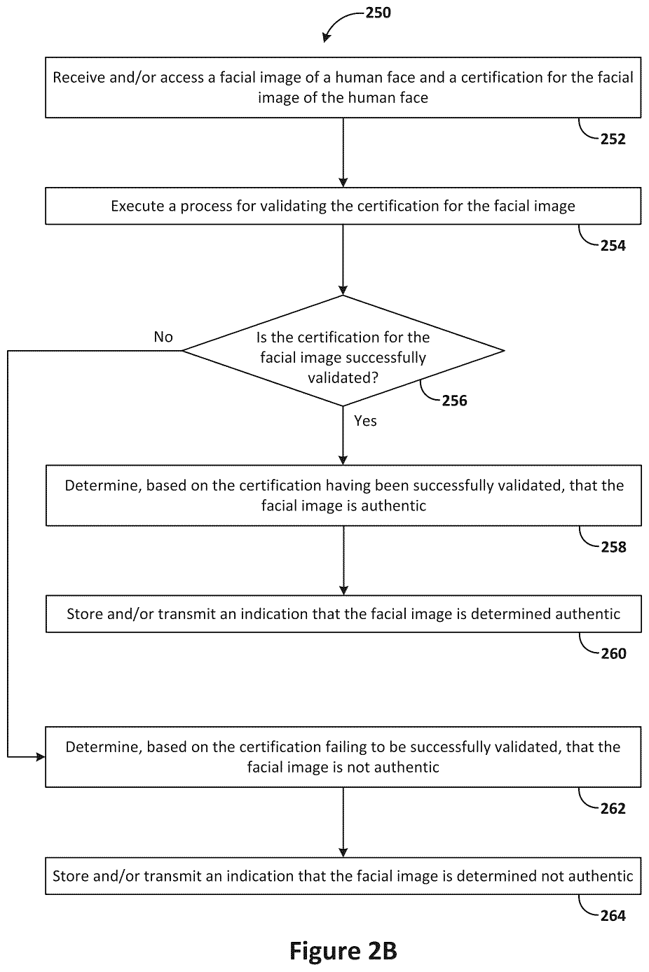

FIG. 1 illustrates a facial image certification system 100 accordance with one or more embodiments. In one or more embodiments, the facial image certification system 100 refers to hardware and/or software configured to perform operations described herein. The facial image certification system 100 performs operations associated with generating certified facial images. The certifications represent a confirmation that a facial image of a human face corresponds to a spatial representation of the human face that was captured at approximately the same time as the facial image. Additionally, or alternatively, the facial image certification system 100 performs operations associated with authenticating facial images based on certifications for the facial images. The system authenticates a facial image by verifying that a certification corresponding to the facial image has been validated. Examples of operations are further described below with reference to FIGS. 2A and 2B.

As used herein, the term “facial image” refers to a visual representation that captures an appearance of a human face. A facial image may include a digital or analog representation of a human face. The representation of the human face in a facial image may include a two-dimensional representation and/or a three-dimensional representation. A facial image may be utilized for identification, analysis, or recognition purposes. A facial image can include one or more photographs, one or more sets of video frames, or other types of digital or analog representations of a human face as well as combinations of these.

The term “spatial representation,” as used herein with reference to a human face, refers to an encoding of a geometric structure and/or surface profile of at least a portion of a human face. A spatial representation of a human face may include a geometric structure of at least a portion of a human face. Additionally, or alternatively, a spatial representation of a human face may include a position of one or more features of a human face. The geometric structure and/or the one or more features of the human face included in the spatial representation may include an encoding of a spatial structure of one or more of the following: eyes, nose, mouth, cheeks, jaw, ears, or relationships between one or more of these. The spatial representation of the human face may include a two-dimensional representation and/or a three-dimensional representation.

As used herein, the term “certified facial image” refers to a facial image of a human face that is associated with a certification that represents verification that the facial image corresponds to a spatial representation of the human face captured at approximately a same time as the facial image.

The term “certification,” as used herein with reference to an element associated with a facial image, includes one or more cryptographic artifacts that can be cryptographically verified, for example, to confirm the integrity, authenticity, or validity of a facial image. Additionally, the certification may include one or more verification artifacts for cryptographically verifying the one or more cryptographic artifacts of the certification. A cryptographic artifact may include one or more of the following: a digital signature, a cryptographic hash, or a blockchain-based certification. A verification artifact may include one or more of the following: a public key, a hash function, a validation path, a Merkle proof, or a blockchain transaction identifier.

As shown in FIG. 1, the system 100 includes a facial image certification generator 102 and one or more data repositories 104. The facial image certification generator 102 includes a set of modules for generating certifications for facial images. Additionally, the facial image certification generator 102 may include a set of modules for generating the facial images that are certified by the facial image certification generator 102. The one or more data repositories 104 may store data associated with the facial image certification generator 102, such as facial images and/or certifications for the facial images. In one example, as shown in FIG. 1, a data repository 104 includes a set of one or more certified facial images 106.

In one example, the system 100 includes one or more data capture devices 108. The one or more data capture devices 108 may include one or more facial image capture components 110 and/or one or more spatial representation capture components 112. The one or more facial image capture components 110 and the spatial representation capture components 112 may be components of separate data capture devices 108 and/or components of a same data capture device 108. The facial image certification generator 102 may be implemented or executed on one or more data capture devices 108. Additionally, or alternatively, the facial image certification generator 102 may be implemented or executed on a computing system that is separate from the one or more data capture devices 108.

The facial image certification generator 102 includes a facial image acquisition module 114 and a spatial representation acquisition module 116. The facial image acquisition module 114 acquires facial images and/or facial image data from a data capture device 108 that includes one or more facial image capture components 110. A facial image capture component 110 may include one or more of the following: an optical camera, an infrared camera, a depth sensor, or a photosensitive pixel array. The facial image acquisition module 114 receives facial images and/or facial image data from the data capture device 108 that includes the one or more facial image capture components 110. In one example, the facial image acquisition module 114 directs commands to the data capture device 108 that includes the one or more facial image capture components 110, and the data capture device 108 utilizes the one or more facial image capture components 110 to capture facial image data and/or generate facial images. Additionally, or alternatively, the data capture device 108 may capture facial image data and/or generate facial images independently from the facial image acquisition module 114. In one example, the data capture device 108 pushes facial image data and/or the facial images to the facial image acquisition module 114 when the facial image data is captured and/or when the facial images are generated. The facial image acquisition module 114 may generate facial images from the facial image data.

The spatial representation acquisition module 116 acquires spatial representations and/or spatial representation data from a data capture device 108 that includes one or more spatial representation capture components 110. A spatial representation capture component 112 may include one or more of the following: a depth sensing device, an active sensing device, a structure light device, a time-of-flight device, a stereo camera device, an infrared emitter, a dot projector, a lidar device, an ultrasonic device, or a photogrammetry device. The spatial representation acquisition module 116 receives spatial representations and/or spatial representation data from the data capture device 108 that includes the one or more spatial representation capture component 112. In one example, the spatial representation acquisition module 116 directs commands to the data capture device 108 that includes the one or more spatial representation capture component 112, and the data capture device 108 utilizes the one or more spatial representation capture component 112 to capture spatial representation data and/or generate spatial representations. Additionally, or alternatively, the data capture device 108 may capture spatial representation data and/or generate spatial representations independently from the spatial representation acquisition module 116. In one example, the data capture device 108 pushes spatial representation data and/or the spatial representations to the spatial representation acquisition module 116 when the spatial representation data is captured and/or when the spatial representations are generated. The spatial representation acquisition module 116 may generate spatial representations from the spatial representation data.

Referring further to FIG. 1, the facial image certification generator 102 includes a comparison module 118 and a certification generation module 120. The comparison module 118 performs operations pertaining to comparing a facial image acquired by the facial image acquisition module 114 to a spatial representation acquired by the spatial representation acquisition module 116. The certification generation module 120 performs operations pertaining to generating a certification for a facial image in response to the comparison module 118 determining that the facial image corresponds to a spatial representation that was captured at approximately a same time as the facial image. Additionally, or alternatively, the certification generation module 120 performs operations pertaining to generating certified facial images 106 in response to the comparison module 118 determining that the facial image corresponds to a spatial representation that was captured at approximately a same time as the facial image. The certified facial images 106 may include the facial image and a certification associated with the facial image. The certifications generated by the certification generation module 120 may include one or more cryptographic artifacts. Additionally, or alternatively, the certifications generated by the certification may include one or more verification artifacts for cryptographically verifying the one or more cryptographic artifacts of the certification.

In one example, the system 100 includes one or more recipient devices 122. The facial image certification generator 102 may be implemented or executed on one or more recipient devices 122. Additionally, or alternatively, the facial image certification generator 102 may be implemented or executed on a computing system that is separate from the one or more recipient devices 122. In one example, the facial image certification generator 102 provides certified facial images 106 to the one or more recipient devices 122. Additionally, or alternatively, the facial image certification generator 102 may provide certified facial images 106 to one or more data repositories 104. In one example, a facial image is considered a certified facial image 106 when the certification generation module 120 generates a certification for the facial image.

As shown in FIG. 1, a recipient device 122 may include a facial image authentication module 124. The facial image authentication module 124 performs operations associated with authenticating a facial image, such as a certified facial image 106, based on a certification associated with the facial image. A facial image may be considered an authenticated facial image 126 when the facial image authentication module successfully validates a certification associated with the facial image. The one or more recipient devices may store authenticated facial images 126, for example, that have been authenticated by the facial image authentication module 124. Additionally, or alternatively, authenticated facial images 126 may be stored in a data repository 104 that represents a component of a recipient device 122 or a component that is separate from a recipient device 122. Certification generation module 120 generates a certification for the facial image.

The one or more recipient devices 122 may include a device associated with one or more of the following: an identity verification system, a facial recognition system, a biometric authentication system, an identification document generation system, an identification document verification system, a surveillance system, a security checkpoint system, a travel security system, a vehicle access system, a border checkpoint system, a high-security computing system, a facility security system, a mobile device security system, a law enforcement identification system, a digital platform identification system, a financial services access system, a fraud prevention system, a mobile banking system, an automatic teller machine security system, a medical records access system, a patient identification system, a medication compliance system, a regulatory compliance system, a customer experience enhancement system, a guest identification system, a student attendance system, or a controlled access system.

In one example, the facial image certification system 100 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

In one or more embodiments, the facial image certification system 100 may include more or fewer components than the components described herein. The components described herein may be local to or remote from each other. The components described herein may be implemented in software and/or hardware. The components described herein may be distributed over multiple applications and/or machines. Multiple components may be combined into one application and/or machine. Operations described with respect to one component may instead be performed by another component. Additional embodiments and/or examples relating to computer networks are described below in Section 5, titled “Computer Networks and Cloud Networks.”

In one or more embodiments, the one or more data repositories 104 of the system 100 may include any type of storage unit and/or device (e.g., a file system, database, collection of tables, or any other storage mechanism) for storing data. Furthermore, the one or more data repositories 104 may include multiple different storage units and/or devices. The multiple different storage units and/or devices may or may not be of the same type or located at the same physical site. Furthermore, a data repository 104 may be implemented or executed on the same computing system as the facial image certification generator 102 and/or on the same computing system as a recipient device 122. Additionally, or alternatively, a data repository 104 may be implemented or executed on a computing system that is separate from the facial image certification generator 102 and the one or more recipient devices 122. The data repository may be communicatively coupled to the facial image certification generator 102 and/or to the one or more recipient devices 122 via a direct connection or via a network.

Referring further to FIG. 1, the system 100 may include a user device interface 128 communicatively coupled or couplable with the facial image certification generator 102. Additionally, or alternatively, the one or more recipient devices and/or the one or more data capture devices may include a user device interface 128. A user device interface 128 may include hardware and/or software configured to facilitate interactions between a user and various aspects of the system 100. The user device interface 128 may render user interface elements and receive input via user interface elements. For example, the user device interface 128 may display outputs generated by the facial image certification system 100. Additionally, or alternatively, the user device interface 128 may be configured to select datasets as inputs to the facial image certification system 100. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 128.

In an embodiment, different components of a user device interface 128 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 128 may be specified in one or more other languages, such as Java, C, or C++.

Additionally, or alternatively, the system 100 may include one or more communications interfaces 130 communicatively coupled or couplable with one or more of the following: the facial image certification generator 102, the one or more data repositories 104, the one or more data capture devices 108, the one or more recipient devices 122, and/or the one or more user device interfaces 128. The one or more communications interface 130 may include hardware and/or software configured to transmit data between respective components of the system and/or to transmit data to and/or from the system. For example, a communications interface 130 may transmit and/or receive data between and/or among one or more of the following: the facial image certification generator 102, the one or more data repositories 104, the one or more data capture devices 108, the one or more recipient devices 122, and/or the one or more user device interfaces 128.

### 3. Example Operations for Generating and Authenticating Facial Images

Referring to FIGS. 2A and 2B, example operations pertaining to a facial image certification system are further described. One or more operations described with reference to FIGS. 2A and 2B may be modified, combined, rearranged, or omitted. Accordingly, the particular sequence of operations described with reference to FIGS. 2A and 2B should not be construed as limiting the scope of one or more embodiments. In one example, the operations may be performed by the one or more components of the system described herein.

### A. Generating Certified Facial Images

Referring to FIG. 2A, the system performs operations 200 pertaining to generating certified facial images. As shown in FIG. 2A, the system captures a facial image of a human face (Operation 202). The system may utilize one or more facial image capture components to capture the facial image. Additionally, the system captures a spatial representation of the human face at approximately a same time as capturing the facial image of the human face (Operation 204). The spatial representation may include a two-dimensional special representation and/or a three-dimensional spatial representation. The system may utilize one or more spatial representation capture components to capture the spatial representation. In one example, the system captures the facial image using a first data capture device and the spatial representation using a second data capture device. Additionally, or alternatively, the system may capture the facial image and the spatial representation using a data capture device that includes one or more facial image capture components and one or more spatial representation capture components. The system may generate the facial image based on data captured by the one or more facial image capture components. Additionally, or alternatively, the system may generate the spatial representation based on data captured by the one or more spatial representation capture components.

In one example, the system captures the facial image and/or the spatial representation in response to an input from a user device interface. The input from the user device interface may initiate operations of the one or more data capture devices to capture the facial image and/or the spatial representation. In one example, the system captures the facial image in response to a first input, for example, from a first user device interface, and the system captures the spatial representation in response to a second input, for example, from a second user device interface. The first input and the second input may occur at approximately a same time such as within a few seconds of one another. Additionally, or alternatively, the system may capture the facial image and the spatial representation in response to a single input from the user device interface. In one example, the system captures the facial image and the spatial representation simultaneously.

In one example, the system captures the facial image by receiving data from one or more data capture devices that push data to the system. A data capture device may push facial images to the system after they are captured by the data capture device. Additionally, or alternatively, the data capture device may push facial image data to the system, and the system may generate a facial image from the facial image data. The system may detect a human face and/or one or more facial features of the human face in the facial image data, for example, using a human facial feature detection process. The system may mark the human face and/or the one or more facial features in the facial image data with a bounding box. Additionally, or alternatively, the system may isolate the human face and/or the facial features from other content in the facial image data.

In one example, the system captures the spatial representation by receiving data from one or more data capture devices that push data to the system. A data capture device may push spatial representations to the system after they are captured by the data capture device.

Additionally, or alternatively, the data capture device may push spatial representation data to the system, and the system may generate a spatial representation from the spatial representation data. The system may detect a human face in spatial representation data, for example, using a human facial feature detection process. The system may mark the human face and/or the one or more facial features in the spatial representation data with a bounding box. Additionally, or alternatively, the system may isolate the human face and/or the facial features from other content in the spatial representation data.

In one example, the system generates the spatial representation by estimating depth based on shading. The system may analyze variations in brightness to estimate depth. The system may generate surface normal based on the shading. The surface normal are vectors that are perpendicular to the surface. The system may integrate the surface normal to estimate depth at various points in the spatial representation. The system may utilize multiple sets of spatial representation data, for example, captured at slightly different angles, to perform the depth estimations based on shading.

In one example, the spatial representation includes a depth map and/or a point cloud. A depth map is a grayscale image where pixel intensity represents depth. A point cloud is a set of data points in space that have coordinates representing a point on a surface.

The human facial feature detection process utilized to detect a human face and/or facial features in facial image data and/or special representation data may include one or more of the following: a feature-based process, a model-based process, and/or a deep learning-based process. The system may utilize different human facial feature detection processes for the facial image data and the spatial representation data. A feature-based process may utilize one or more of the following: principal component analysis (PCA), linear discriminant analysis (LDA), local binary patterns (LBP), or histogram of oriented gradients (HOG). The system may utilize PCA to reduce the dimensionality of the facial image data, for example, to create “eigenfaces” that represent different facial features. The system may utilize LDA to enhance PCA, for example, to handle different lighting and/or various facial expressions. The system may utilize LBP to encode facial features by comparing the neighborhood of different pixels and creating a binary pattern that represents textures of the face. The system may utilize HOG to characterize a distribution of intensity gradients in localized portions of a facial image, for example, to capture a structure and/or shape of the human face. Additionally, or alternatively, a feature-based process may include a boundary tracing algorithm. A model-based process may utilize an active shape model and/or an active appearance model. The system may utilize an active shape model to capture the shape of facial features by aligning and deforming a predefined shape to fit the human face in the facial image. The system may utilize an active appearance model to capture both a shape and a texture (e.g., appearance) of the human face. The system may combine the shape and texture to provide a more accurate facial image. A deep learning-based process may utilize one or more convolutional neural networks (CNNs). Example CNNs include VGG-Face, FaceNet, DeepFace, and ARCFace.

After capturing the facial image and the spatial representation, the system executes a process for determining whether the facial image corresponds to the spatial representation (Operation 206). In one example, the process for determining whether the facial image corresponds to the spatial representation includes comparing one or more features of the facial image to one or more features of the spatial representation. Additionally, or alternatively, the process for determining whether the facial image corresponds to the spatial representation may include comparing a time when the facial image is captured to a time when the spatial representation is captured.

In one example, the system compares one or more features of the facial image to one or more features of the spatial representation. The system may utilize a deep learning-based process to compare the facial image to the spatial representation. In one example, the system generates a set of one or more facial image embeddings and a set of one or more spatial representation embeddings for comparing one or more features of the facial image to one or more features of the spatial representation. An embedding may include a vector that encodes one or more facial features. The set of one or more facial image embeddings represent one or more facial features extracted from the facial image. The set of one or more spatial representation embeddings represent one or more facial features extracted from the spatial representation. The system may normalize the facial image embeddings and/or spatial representation embeddings, for example, to account for variations in lighting, pose, and/or expression. In one example, the system generates a facial image embedding that includes a vector representing the entire human face in the facial image. Additionally, or alternatively, the system may generate a spatial representation embedding that includes a vector representing the entire human face in the spatial representation.

After generating the set of one or more facial image embeddings and the set of one or more spatial representation embeddings, the system compares the one or more facial image embeddings to the one or more spatial representation embeddings to determine whether the one or more facial image embeddings sufficiently match the one or more spatial representation embeddings. The system may determine a Euclidian distance or a cosine similarity between a vector of the facial image embedding and a vector of the spatial representation embedding. In one example, the system determines a comparison score. The comparison score may be based on the Euclidian distance or cosine similarity. Additionally, or alternatively, the comparison score may represent an aggregate of multiple comparisons of a facial image embedding to a spatial representation embedding. The comparison score represents how similar or different the facial image and the spatial representation are to one another.

The system determines whether the facial image corresponds to the three-dimensional spatial representation (Operation 208). To determine whether the facial image corresponds to the three-dimensional spatial representation, the system may compare the comparison score to a score threshold. When the comparison score satisfies the score threshold, the system determines that the facial image corresponds to the spatial representation. When the score threshold is unmet, the system determines that the facial image does not correspond to the spatial representation.

Additionally, or alternatively, the system may determine a difference between a time when the facial image is captured and a time when the spatial representation is captured. The system may compare the difference in time to a time threshold. When the difference in time satisfies the time threshold, the system determines that the facial image corresponds to the spatial representation. When the time threshold is unmet, the system determines that the facial image does not correspond to the spatial representation. In one example, the system determines that that the facial image corresponds to the spatial representation when both the score threshold and the time threshold are satisfied.

When the system determines that the facial image corresponds to the spatial representation, the system generates a certification corresponding to the facial image (Operation 210). In one example, the system generates the certification utilizing a cryptographic protocol that is pre-arranged, for example, between a facial image certification generator and one or more recipient devices. In one example, the certification includes a cryptographic artifact such as a digital signature. The system may generate the cryptographic artifact, such as a digital signature, utilizing a private key. The system may provide a verification artifact for verifying the cryptographic artifact. In one example, the verification artifact includes a public key corresponding to the private key. In one example, the system includes the verification artifact as a component of the certification. Additionally, or alternatively, the system may provide the verification artifact to one or more recipient devices separate from the certification.

After generating the certification, the system stores and/or transmits the certification for authenticating the facial image (Operation 212). The system may store and/or transmit the certification together with the facial image. In one example, the system stores and/or transmits a certified facial image that includes the certification and the facial image. The system may store the certification and/or the facial image in one or more data repositories. Additionally, or alternatively, the system may transmit the certification and/or the facial image to one or more recipient devices.

### B. Generating a Test Suite Based a Series of Input Prompts

Referring to FIG. 2B, the system performs operations 250 pertaining to authenticating facial images. The operations 250 may be performed by a recipient system that authenticates facial images. As shown in FIG. 2B, the recipient system receives and/or accesses a facial image of a human face and a certification for the facial image of the human face (Operation 252). The recipient system may receive the facial image and/or the certification from a certification generating system that generated the certification, for example, as described with reference to FIG. 2A. Additionally, or alternatively, the recipient system may access the facial image and/or the certification from a data repository, for example, in response to an input from a user device interface. In one example, the recipient system receives and/or accesses certified facial images that include a facial image and a certification associated with the facial image.

After receiving and/or accessing the facial image and the certification for the facial image, the system executes a process for validating the certification (Operation 254). The process for validating the certification may include utilizing a validation artifact to validate the certification. The certification may include a cryptographic artifact. The system may access the cryptographic artifact and utilize the validation artifact to validate the cryptographic artifact. In one example, the cryptographic artifact includes a digital signature generated with a private key, and the validation artifact includes a public key corresponding to the private key. The system may utilize the private key to validate the digital signature.

The system determines whether the certification for the facial image is successfully validated (Operation 256). In one example, the system determines that the certification is successfully validated. When the system determines that the certification is successfully validated, the system determines, based on the certification having been successfully validated, that the facial image is authentic (Operation 258). When the system determines that the facial image is authentic, the system stores and/or transmits an indication that the facial image is determined authentic (Operation 260). In one example, the indication that the facial image is authentic may include an additional cryptographic artifact generated by the recipient system. For example, the recipient system may digitally sign at least a portion of the certified facial image (e.g., the facial image and/or the certification) to indicate that the certification has been successfully validated and/or that the facial image is determined to be authentic based on the certification having been successfully validated.

The system may utilize the facial image in one or more processes for verifying a person's face depicted by the facial image after the system determines that the facial image is authentic and/or after storing and/or transmitting the indication that the facial image is determined authentic. The one or more processes may be performed by a biometric verification system. Additionally, or alternatively, the facial image may be utilized on one or more physical and/or digital identification documents after the system determines that the facial image is authentic and/or after storing and/or transmitting the indication that the facial image is determined authentic.

In one example, the system determines that the certification for the facial image is not successfully validated (Operation 256). When the system determines that the certification is not successfully validated, the system determines, based on the certification failing to be successfully authenticated, that the facial image is not authentic (Operation 262). When the system determines that the facial image is not authentic, the system stores and/or transmits an indication that the facial image is determined not authentic (Operation 264). The system may refrain from utilizing the facial image in a process for verifying a person's face depicted by the facial image in response to determining that the facial image is not authentic.

### 4. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared among multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, one or more of the following: Software-as-a-Service (SaaS), Platform-as-a-Service (PaaS), or Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, one or more of the following: a private cloud, a public cloud, or a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 5. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications that are designed as a single fixed unit and generally comprise a single logical executable. With microservice applications, different microservices are independently deployable as separate executables. Microservices may communicate using HTTP messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.).

### Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and indicate whether to increase, decrease, or delete the threshold. Additionally, or alternatively, the input might request the microservice application to create new in-application alert thresholds. The in-application alerts may trigger alerts to the user while logged into the application or may trigger alerts to the user using default or user-selected alert mechanisms available within the microservice application itself rather than through other applications plugged into the microservices manager.

In one or more embodiments, the microservice application may generate and provide an output based on input that identifies, locates, or provides historical data and defines the extent or scope of the requested output. The action, when triggered, causes the microservice application to provide, store, or display the output, for example, as a data model or as aggregate data that describes a data model.

### 6. Hardware Overview

According to one embodiment, the techniques described herein are implemented by one or more special-purpose computing devices. The special-purpose computing devices may be hard-wired to perform the techniques or may include digital electronic devices, such as one or more application-specific integrated circuits (ASICs), field programmable gate arrays (FPGAs), or network processing units (NPUs) that are persistently programmed to perform the techniques. Also, the special-purpose computing devices may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

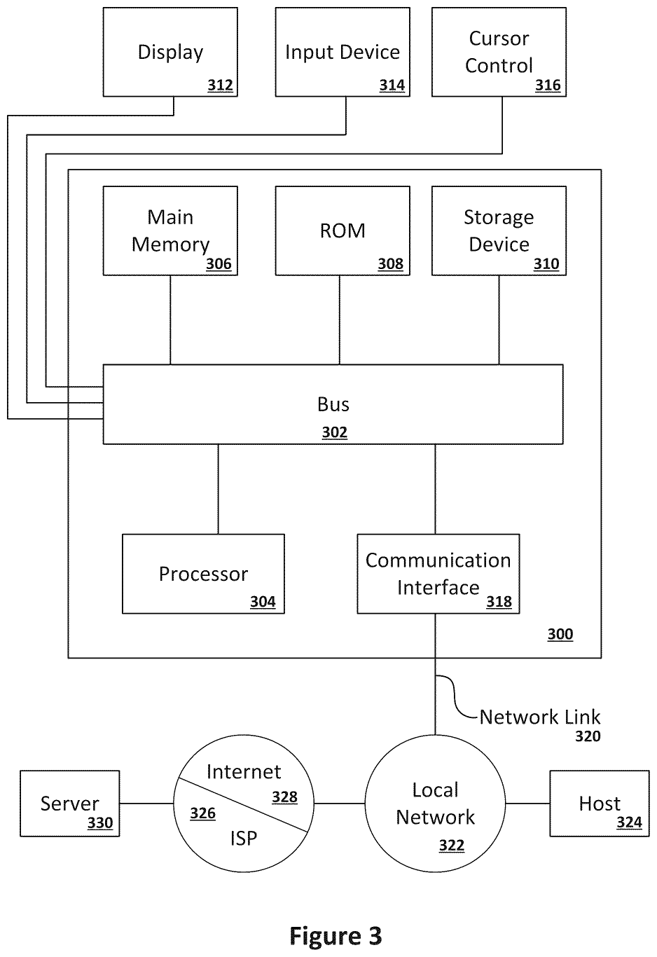

For example, FIG. 3 is a block diagram that illustrates a computer system 300 upon which an embodiment of the disclosure may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or a Solid-State Drive (SSD) is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware, and/or program logic that in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic, or optical signals that carry digital data streams. The signals through the various networks and the signals on network link 320 and through communication interface 318, that carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### 7. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
capturing a facial image of a human face;
at approximately a same time as capturing the facial image of the human face, capturing a three-dimensional spatial representation of the human face;
determining that the facial image corresponds to the three-dimensional spatial representation;
responsive to determining that the facial image corresponds to the three-dimensional spatial representation, generating a certification corresponding to the facial image;
storing and/or transmitting the certification for authenticating the facial image.

2. The one or more non-transitory computer-readable media of claim 1, wherein the operations further comprise:
transmitting the certification and the facial image to a recipient computing device, wherein based on the certification, the recipient computing device determines that the facial image is authentic.

3. The one or more non-transitory computer-readable media of claim 1, wherein the facial image of the human face comprises a two-dimensional spatial representation of the human face.

4. The one or more non-transitory computer-readable media of claim 1, wherein determining that the facial image corresponds to the three-dimensional spatial representation comprises:
comparing the facial image to the three-dimensional spatial representation.

5. The one or more non-transitory computer-readable media of claim 4, wherein comparing the facial image to the three-dimensional spatial representation comprises:
extracting a first set of information from the facial image;
extracting a second set of information from the three-dimensional spatial representation;
determining a relationship between the first set of information and the second set of information;
determining that the facial image corresponds to the three-dimensional spatial representation based on the relationship between the first set of information and the second set of information.

6. The one or more non-transitory computer-readable media of claim 5,
wherein comparing the facial image to the three-dimensional spatial representation comprises:
computing a similarity score based at least in part on a comparison of a first set of one or more elements of the facial image to a second set of one or more elements of the three-dimensional spatial representation; and
wherein determining that the facial image corresponds to the three-dimensional spatial representation comprises:
determining that the similarity score meets a similarity threshold.

7. The one or more non-transitory computer-readable media of claim 1, wherein capturing the three-dimensional spatial representation of the human face at approximately the same time as capturing the facial image of the human face comprises:
utilizing a first device component to capture the facial image of the human face; and
utilizing a second device component to capture the three-dimensional spatial representation of the human face.

8. The one or more non-transitory computer-readable media of claim 1, wherein the certification comprises a digital signature.

9. The one or more non-transitory computer-readable media of claim 8, wherein generating the certification comprises:
generating an artifact comprising at least a portion of the facial image;
applying a cryptographic hash function to the artifact to generate a hash value; and
encrypting the hash value using an encryption key to generate the digital signature;
generating a certification package comprising the artifact and the digital signature.

10. The one or more non-transitory computer-readable media of claim 1, wherein the operations further comprise:
applying a first facial recognition algorithm to the facial image, wherein the first facial recognition algorithm determines a first set of one or more facial elements of the human face from the facial image;
applying a second facial recognition algorithm to the three-dimensional spatial representation, wherein the second facial recognition algorithm determines a second set of one or more facial elements of the human face from the three-dimensional spatial representation;
comparing the first set of one or more facial elements to the second set of one or more facial elements.

11. The one or more non-transitory computer-readable media of claim 1, wherein capturing the three-dimensional spatial representation at approximately the same time as capturing the facial image comprises:
capturing the facial image at a first time;
capturing the three-dimensional spatial representation at a second time, validating that a time difference between the first time and the second time satisfies a time threshold;
generating the certification responsive at least in part to successfully validating that the time difference satisfies the time threshold.

12. A method, comprising:
capturing a facial image of a human face;
at approximately a same time as capturing the facial image of the human face, capturing a three-dimensional spatial representation of the human face;
determining that the facial image corresponds to the three-dimensional spatial representation;
responsive to determining that the facial image corresponds to the three-dimensional spatial representation, generating a certification corresponding to the facial image;
storing and/or transmitting the certification for authenticating the facial image;
wherein the method is performed by at least one device including a hardware processor.

13. The method of claim 12, further comprising:
transmitting the certification and the facial image to a recipient computing device, wherein based on the certification, the recipient computing device determines that the facial image is authentic.

14. The method of claim 12, further comprising:
extracting a first set of information from the facial image;
extracting a second set of information from the three-dimensional spatial representation;
determining a relationship between the first set of information and the second set of information;
determining that the facial image corresponds to the three-dimensional spatial representation based on the relationship between the first set of information and the second set of information.

15. The method of claim 14, wherein determining that the facial image corresponds to the three-dimensional spatial representation based on the relationship between the first set of information and the second set of information comprises:
computing a similarity score based at least in part on a comparison of a first set of one or more elements of the facial image to a second set of one or more elements of the three-dimensional spatial representation; and
determining that the similarity score meets a similarity threshold.

16. The method of claim 12, wherein capturing the three-dimensional spatial representation of the human face at approximately the same time as capturing the facial image of the human face comprises:
utilizing a first device component to capture the facial image of the human face; and
utilizing a second device component to capture the three-dimensional spatial representation of the human face.

17. The method of claim 12, wherein generating the certification comprises:
generating an artifact comprising at least a portion of the facial image,
applying a cryptographic hash function to the artifact to generate a hash value,
encrypting the hash value using an encryption key to generate a digital signature,
generating a certification package comprising the artifact and the digital signature.

18. The method of claim 12, further comprising:
applying a first facial recognition algorithm to the facial image, wherein the first facial recognition algorithm determines a first set of one or more facial elements of the human face from the facial image;
applying a second facial recognition algorithm to the three-dimensional spatial representation, wherein the second facial recognition algorithm determines a second set of one or more facial elements of the human face from the three-dimensional spatial representation;
comparing the first set of one or more facial elements to the second set of one or more facial elements.

19. The method of claim 12, wherein capturing the three-dimensional spatial representation at approximately the same time as capturing the facial image comprises:
capturing the facial image at a first time;
capturing the three-dimensional spatial representation at a second time,
validating that a time difference between the first time and the second time satisfies a time threshold;
generating the certification responsive at least in part to successfully validating that the time difference satisfies the time threshold.

20. A system comprising:
at least one device including a hardware processor;
the system being configured to perform operations comprising:
capturing a facial image of a human face;
at approximately a same time as capturing the facial image of the human face, capturing a three-dimensional spatial representation of the human face;
determining that the facial image corresponds to the three-dimensional spatial representation;
responsive to determining that the facial image corresponds to the three-dimensional spatial representation, generating a certification corresponding to the facial image;
storing and/or transmitting the certification for authenticating the facial image.
